(19) United States
(12) Patent Application Publication
(10) Pub. No.: US 2020/0325055 A1
(43) Pub. Date: Oct. 15, 2020

(54) MANUFACTURING OF CONTINUOUS MINERAL FIBERS

(71) Applicant: KNAUF INSULATION, Vise (BE)

(72) Inventors: Gerard DEMOTT, Majcichov (SK); Bostjan MAROLT, Poljane (SI); David DUCARME, Wavre (BE)

(21) Appl. No.: 16/858,687

(22) Filed: Apr. 26, 2020

Related U.S. Application Data
(63) Continuation of application No. 16/781,208, filed on Feb. 4, 2020.
Application No. 16/781,208 is a continuation of application No. 16/684,852, filed on Nov. 15, 2019, now abandoned.
Application No. 16/684,852 is a continuation of application No. 16/530,669, filed on Aug. 2, 2019, now abandoned.
Application No. 16/530,669 is a continuation of application No. 15/546,277, filed on Jul. 25, 2017, now abandoned.

(30) Foreign Application Priority Data
Jan. 27, 2015 (GB) 1501308.9

(51) Int. Cl. C03B 5/183; C03C 13/06; C03B 5/235; C03B 5/44; C03C 3/087; F27B 3/20

(52) U.S. Cl. CPC C03B 5/183; C03C 13/06; F27B 3/20; C03B 5/44; C03C 3/087; C03B 5/2356

(57) ABSTRACT

Continuous basalt fibers are produced by melting basalt rock in a submerged combustion melter, and by forming said melt into continuous basalt fibers.

### CROSS-REFERENCE TO RELATED APPLICATIONS

This application is a continuation of U.S. application Ser. No. 16/781,208, filed Feb. 4, 2020, which is a continuation of U.S. application Ser. No. 16/684,852, filed Nov. 15, 2019, which is a continuation of U.S. application Ser. No. 16/530,669 (now abandoned), filed Aug. 2, 2019, which is a continuation of U.S. application Ser. No. 15/546,277 (now abandoned), filed Jul. 25, 2017, which is a U.S. national counterpart application of International Application Serial No. PCT/EP2016/051733, filed Jan. 27, 2016, under 35 U.S.C. § 371, which claims priority to GB Application Serial No. 1501308.9, filed Jan. 27, 2015, the disclosures of which are hereby incorporated herein by reference.

### TECHNICAL FIELD

The present invention relates to an improved process for the manufacturing of continuous mineral fibers, more particularly continuous basalt fibers. It further relates to an equipment for the production of continuous mineral fibers.

### BACKGROUND

Basalt fibers are used as reinforcing materials in different types of composite materials, such as polymeric friction materials, car bodies, sports equipment, but also in concrete. They may also be used as heat protection in different applications. New applications are developed on an ongoing basis. Basalt fibers are very fine with diameters of about 5 to 15 μm, sometimes up to 25 μm, and offer better mechanical properties than glass fibers. While their mechanical properties remain below those of carbon fibers, their price is significantly lower than the price of carbon fibers.

Basalt fibers are made essentially from basalt rock which is melted above about 1400° C., with no significant addition of further raw materials, other than some processing additives, and then extruded through appropriate dies. Basalt generally comprises 45.0-60.0 wt % SiO2, preferably 45.0 to 55.0 wt % SiO2, 12.0-25.0 wt % Al2O3, preferably 12.0-18.0 wt % Al2O3, 5.0-25.0 wt % total iron oxide expressed as Fe2O3, preferably 10.0-18.0 total iron oxide, total alkali of 2.0-6.0 wt %, 5.0-25.0 wt % CaO, preferably 5.0 to 13.0 or even below 10.0 wt %, 4.0-25.0 wt % MgO, preferably 5.0-12.0 wt % MgO, and 0.0-5.0 wt % TiO2. In basalt fibers, the iron oxide content is generally relatively high, more than 12 wt %, or 13 wt %, or even 15 wt %, with rather reduced CaO content. The Na2O content may vary between 0.5 and 5.0 wt % and K2O may vary between the same limits. Typical formulations may comprise the basalt rock composition plus processing aids, including but not limited to TiO2.

The production of basalt fibers requires high energy inputs, and there is an ever increasing need for improvement of the energy efficiency of the manufacturing process.

Moreover, because of the highly corrosive nature of the raw materials and melt to be treated, the refractory lining of the furnaces in which the basalt rock is melted needs to be repaired or replaced after relatively short time periods. In addition, the melt is contaminated with particles or elements worn off the refractory furnace lining. There is hence a need to find a way to overcome that technical problem.

### SUMMARY

According to the invention, a process for the manufacturing of continuous mineral fibers may comprise introducing solid batch material for preparation of continuous mineral fibers into a melter, melting the solid batch material in the melter by submerged combustion, and forming the melt into continuous mineral fibers, such as by extrusion through appropriate filament bushings.

The process may be carried out using a method and/or melter disclosed in any of WO 2015/014919, WO 2015/014920 or WO 2015/014921, each of which is hereby incorporated by reference.

According to a preferred aspect of the present invention, the raw material consists essentially in basalt rock. The continuous fibers then are basalt fibers.

### BRIEF DESCRIPTION OF THE DRAWINGS

FIGS. 1a and 1b are schematic representations of a toroidal flow pattern;

FIG. 2 shows schematically a vertical section through a melter followed by a an extrusion device; and

FIG. 3 is a schematic representation of a burner layout.

### DETAILED DESCRIPTION

Submerged combustion melters are known. These melters are characterized by the fact that they include one or more burner nozzles arranged below the surface of the melt, in a lance, in the melter walls and/or melter bottom, preferably in the melter bottom, such that the burner flame and/or combustion products pass through the melt and transfer energy directly to the melt.

Such burners arranged below the surface of the melt are herein sometimes referred to as submerged burners; it being understood that they are submerged when melt is present in the melter.

More particularly in the case of basalt, the melting temperature is comprised between 1350 and 1450, preferably higher than 1400° C.

The submerged combustion melter ensures efficient mixing in the melt, and homogenizes the melt in terms of temperature profile and composition, leading to a high quality fiber product. The stirring reduces required residence time in the melter prior to withdrawal for downstream forming. It also favors the absorption of raw material into the melt and improves heat transfer to fresh raw material. Fresh raw material may be charged into the melter as relatively large stones and does not require grinding into fine granular size. The high turbulence generated in the melt maintains it at the required viscous state suitable for fiberization, at a temperature below the temperature normally required in standard tank melters of basalt rock for fiberization into continuous fibers.

The melt contained in the submerged combustion melter is advantageously maintained in a turbulent state. It is known that submerged combustion generates high agitation and turbulence in the melt bath, because of the combustion gases injected at high pressure into the melt and because of convection flows thereby generated in the melt. Preferably, the submerged burners are controlled such that the volume of the turbulent melt is at least 8%, more preferably at least 10%, even more preferably at least 15%, higher than the volume it would have without any burners firing. It has been found that the gas injection into the liquid melt and the convection flows thereby generated in the melt reduce the density thereof. Suitable control of the oxy-fuel burners generates the desired density reduction or volume increase. Preferably, the process is run such that no significant foam layer or no foam layer at all is generated over the top of the melt level. It has been found that such a foam layer is disadvantageous for the energy transfer within the melter, and hence the efficiency thereof.

For the sake of clarity and completeness, the level the melt would be at when no burners are firing may be calculated on the basis of the melt composition and/or verified by allowing the melt to freeze in the melter. The level of turbulent melt may be determined by an appropriate measuring device, such as a known laser pointer or similar device, which averages melt levels over a given period of time, such as 1 or 5 minutes.

The increased volume or reduced density of the melt bath is considered a reflection of the turbulence level in the melt; the more turbulent the melt, the more gas bubbles are absorbed within the melt and thus “aerate” the melt. A reduced foam layer over the top of the melt level further reflects that the gas bubbles generated by the gas injection are maintained within the melt bath, rather than to accumulate on the surface thereof.

The homogeneity of the melt composition is an important factor in the extrusion of low diameter fibers in a continuous fashion. Further, a highly homogenous melt also impacts the quality of the final product, including the mechanical and chemical properties. Homogeneity of the melt through the extrusion process further reduces the rupture of the continuous fiber in the course of the extrusion process.

Furthermore, the melting chamber walls may comprise double steel walls separated by circulating cooling liquid, preferably water. Particularly in the case of a cylindrical melting chamber, such assembly is relatively easy to build and is capable of resisting high mechanical stresses. A cylindrical shape of the melter facilitates balance of stresses on the outside wall. As the walls are cooled, for example water cooled, melt preferably solidifies and forms a protective layer on the inside of the melter wall. The melter assembly may not require any internal refractory lining and therefore needs less or less costly maintenance. In addition, the melt is not contaminated with undesirable components of refractory material normally eroded from an internal refractory lining. The internal face of the melter wall may advantageously be equipped with tabs or pastilles or other small elements projecting towards the inside of the melter. These may help in constituting and fixing a layer of solidified melt on the internal melter wall generating a lining having thermal resistance and reducing the transfer of heat to the cooling liquid in the double walls of the melter.

The melter may be equipped with heat recovery equipment. Hot fumes from the melter may be used to preheat raw material or the thermal energy contained in them may be recovered and used otherwise. Similarly, the thermal energy contained in the cooling liquid circulating between the two walls of the melter may also be recovered for heating or other purposes.

Overall the energy efficiency of submerged combustion melters is significantly improved compared to conventional tank melters.

The raw materials may be loaded through an opening in the melter wall, above the melt surface. Said opening may be opened and closed, for example by a piston, to minimize escape of heat and fumes. Raw material may be prepared and loaded into an intermediate chute and subsequently fall into the melter, in an opposite direction to escaping fumes, onto the melt surface. This countercurrent flow may advantageously preheat the raw materials. In the alternative, the raw materials may be charged below the level of the melt, by way of a screw feeder or a hydraulic feeder.

Melt may be withdrawn continuously or batch wise from the melter for further forming in appropriate extrusion or bushing equipment. Where raw material is loaded close to the melter wall, the melt outlet is preferably arranged opposite the material inlet. In the case of discontinuous discharge of melt, a discharge opening maybe controlled by, for example, a ceramic piston. In the alternative a syphon-type discharge may be used which controls the melt level in the melter.

The submerged burners preferably inject high pressure jets of combustion products into the melt that is sufficient to overcome the liquid pressure and to create forced upward travel of the flame and combustion products. The speed of the combustion and/or combustible gases, notably at the exit from the burner nozzle(s), may be ≥60 m/s, ≥100 m/s or ≥120 m/s and/or ≤350 m/s, ≤330 m/s, ≤300 or ≤200 m/s. Preferably the speed of the combustion gases is in the range of about 60 to 300 m/s, preferably 100 to 200, more preferably 110 to 160 m/s.

According to a preferred embodiment, the submerged combustion is performed such that a substantially toroidal melt flow pattern is generated in the melt, having a substantially vertical central axis of revolution, comprising major centrally inwardly convergent flows at the melt surface; the melt moves downwardly at proximity of the vertical central axis of revolution and is recirculated in an ascending movement back to the melt surface, thus defining a substantially toroidal flow pattern.

The generation of such a toroidal flow pattern ensures highly efficient mixing of the melt and absorption of raw material into the melt, and homogenizes the melt in terms of temperature profile and composition, thus leading to high quality final product.

Advantageously, the melting step comprises melting the solid batch material, in a submerged combustion melter by subjecting the melt to a flow pattern which when simulated by computational fluid dynamic analysis shows a substantially toroidal melt flow pattern in the melt, comprising major centrally inwardly convergent flow vectors at the melt surface, with the central axis of revolution of the toroid being substantially vertical.

At the vertical axis of revolution of said toroidal flow pattern, the flow vectors have a downward component reflecting significant downward movement of the melt in proximity of said axis. Towards the melter bottom, the flow vectors change orientation showing outward and then upward components.

Preferably the fluid dynamics model is code ANSYS R14.5, taking into consideration the multi-phase flow field ranging from solid batch material to liquid melt and gas generated in the course of the conversion, and the batch-to-melt conversion.

A toroidal melt flow pattern may be obtained using submerged combustion burners arranged at the melter bottom in a substantially annular burner zone imparting a substantially vertically upward directed speed component to the combustion gases. Advantageously, the burners are arranged with a distance between adjacent burners of about 250-1250 mm, advantageously 500-900 mm, preferably about 600-800, even more preferably about 650-750 mm. It is preferred that adjacent flames do not merge.

Each burner axis and/or a speed vector of the melt moving upwards over or adjacent to the submerged burners may be slightly inclined from the vertical, for example by an angle which is ≥1°, ≥2°, ≥3° or ≥5 and/or which is ≤30°, preferably ≤15°, more preferably ≤10°, notably towards the center of the melter. Such an arrangement may improve the flow and directs melt flow away from the outlet opening and/or towards a center of the melter thus favoring a toroidal flow and incorporation of raw material in to the melt.

According to one embodiment, each central burner axis is inclined by a swirl angle with respect to a vertical plane passing through a central vertical axis of melter and the burner center. The swirl angle may be ≥1°, ≥2°, ≥3°, ≥5° and/or ≤30°, ≤20°, ≤15° or ≤10°. Preferably, the swirl angle of each burner is about the same. Arrangement of each burner axis at a swirl angle imparts a slightly tangential speed component to the upward blowing flames, thus imparting a swirling movement to the melt, in addition to the toroidal flow pattern.

The burner zone is defined as a substantially annular zone. Burner arrangements, for example on an elliptical or ovoid line within the relevant zone are possible, but the burners are preferably arranged on a substantially circular burner line.

Preferably, the flow pattern comprises an inwardly convergent flow at the melt surface followed by a downwardly oriented flow in proximity of the central axis of revolution of the toroid. Said central axis of revolution advantageously corresponds to the vertical axis of symmetry of the melter. By axis of symmetry is meant the central axis of symmetry and, if the melter shows a transversal cross-section which does not have any single defined axis of symmetry, then the axis of symmetry of the circle in which the melter section is inscribed. The downwardly oriented flow is followed by an outwardly oriented flow at the bottom of the melter and a substantially annular upward flow at proximity of the burners, reflecting recirculation of melt toward the burner zone and in an ascending movement back to the melt surface, thus defining a substantially toroidal flow pattern.

The inwardly convergent flow vectors at the melt surface advantageously show a speed comprised between 0.1-3 m/s. The downward oriented speed vectors at proximity of the vertical central axis of revolution are preferably of significant magnitude reflecting a relatively high speed of material flowing downwardly. The downward speed vectors may be between 0.1-3 m/s. The melt and/or the raw materials within the melter, at least at one portion of the melter and notably at the melt surface (particularly inwardly convergent flow vectors at the melt surface) and/or at or proximate a vertical central axis of revolution, may reach a speed which is ≥0.1 m/s, ≥0.2 m/s, ≥0.3 m/s or ≥0.5 m/s and/or which is ≤2.5 m/s, ≤2 m/s, ≤1.8 m/s or ≤1.5 m/s.

The preferred toroidal flow pattern ensures highly efficient mixing and homogenizes the melt in terms of temperature profile and composition. It also favors the absorption of raw material into the melt and improves heat transfer to fresh raw material. This reduces required residence time in the melter prior to withdrawal, while avoiding or at least reducing the risk of raw material short cutting the melt circulation.

In one preferred embodiment, the burners are arranged at a distance of about 250-750 mm from the side wall of said melting chamber; this favors the preferred flow described above and avoids flame attraction to the melting chamber side walls. Too small a distance between burners and side wall may damage or unnecessarily stress the side wall. While a certain melt flow between burner and wall may not be detrimental and may even be desirable, too large a distance will tend to generate undesirable melt flows and may create dead zones which mix less with the melt in the center of the melter and lead to reduced homogeneity of the melt.

The distance between submerged burners is advantageously chosen such as to provide the desired toroidal flow pattern within the melt but also to avoid that adjacent flames merge. While this phenomenon depends on many parameters such as temperature and viscosity of the melt, pressure and other characteristics of the burners, it has been found advantageous to select a burner circle diameter comprised between about 1200 and 2000 mm. Depending on burner type, operating pressure and other parameters, too large a diameter will lead to diverging flames; too narrow a diameter will lead to merging flames.

Preferably at least 6 burners are provided, for example arranged on a burner circle line, more preferably 6 to 10 burners, even more preferably 6 to 8 burners, depending on the melter dimensions, burner dimensions, operating pressure and other design parameters.

Each burner or each of a plurality of a group of burners, for example opposed burners, may be individually controlled. Burners close to a raw material discharge may be controlled at different, preferably higher gas speeds and/or pressures than adjacent burners, thus allowing for improved heat transfer to the fresh raw material that is being loaded into the melter. Higher gas speeds may be required only temporarily, that is, in the case of batch wise loading of fresh raw material, just during the time period required for absorption of the relevant load into the melt contained in the melter.

It may also be desirable to control burners that are located close to a melt outlet at a lower gas speed/pressure in order not to disturb the outlet of the melt.

The melting chamber is preferably substantially cylindrical in cross section; nevertheless, it may have an elliptical cross section or polygonal cross section showing more than 4 sides, preferably more than 5 sides.

The composition of the melt produced may typically comprise:

| | Example 1 composition | Example 2 composition |
|---|---|---|
| | (% weight) | (% weight) |
| SiO₂ | 51.25 | 51.4 |
| Al₂0₃ | 15.75 | 13.3 |
| CaO | 8.13 | 8.6 |
| Fe₂O₃ (total iron) | 13.49 | 14.6 |
| MgO | 6.63 | 5.1 |
| Na2O | 2.09 | 2.7 |
| K2O | 0.49 | 0.7 |
| TiO2 | 1.62 | |
| MnO | 0.21 | |

possibly with minor amounts of other oxides to add up to 100%.

An embodiment of a melter suitable for use in accordance with the present invention is described below, with reference to the appended drawings of which:

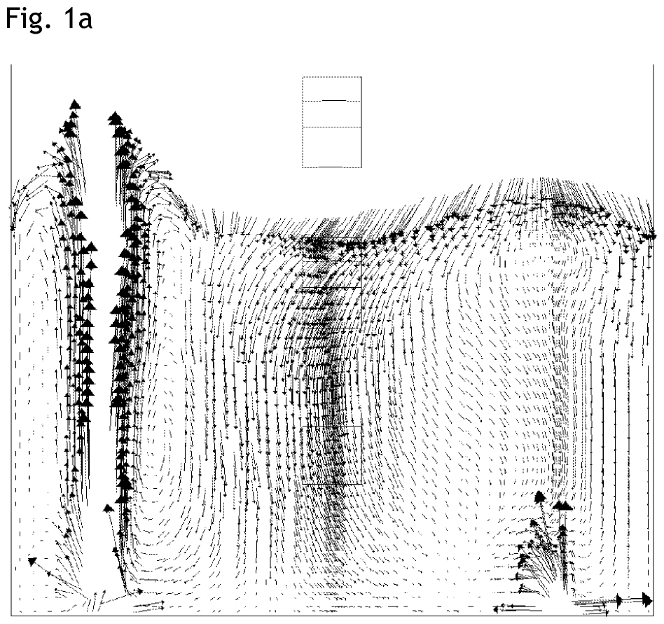

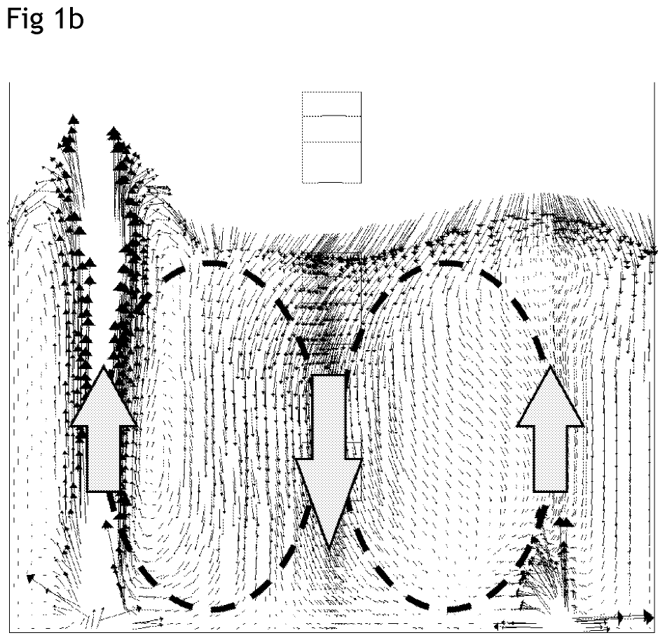

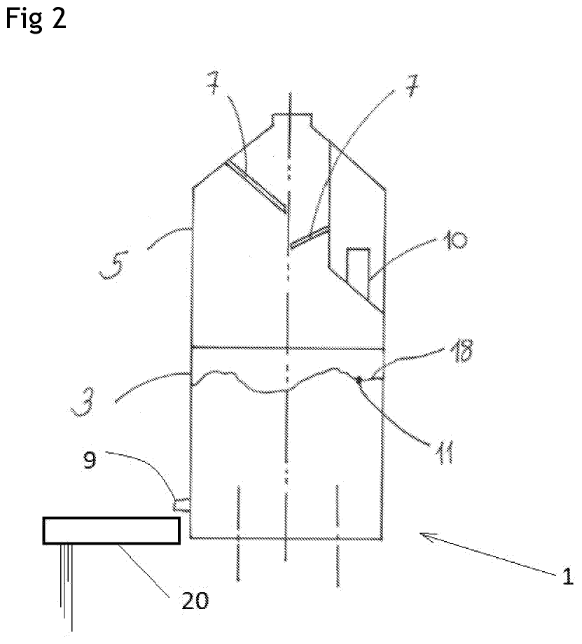

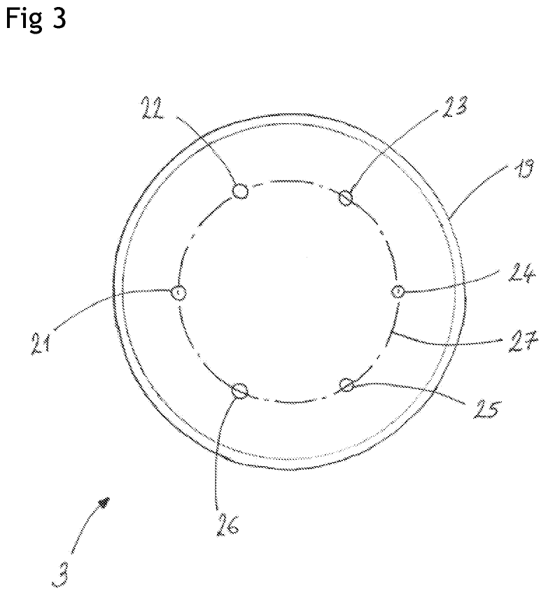

FIGS. 1a and 1b are schematic representations of a toroidal flow pattern;
FIG. 2 shows schematically a vertical section through a melter followed by a an extrusion device; and
FIG. 3 is a schematic representation of a burner layout.

With reference to FIGS. 1a and 1b, a toroidal flow pattern is preferably established in which melt follows an ascending direction close to submerged burners 21, 22, 23, 24, 25, 26 which are arranged on a circular burner line 27, flows inwardly towards the center of the circular burner line at the melt surface, and flows downwards in the proximity of the said center. The toroidal flow generates agitation in the melt, ensures good stirring of the melt, and absorption of raw material into the melt.

The illustrated melter 1 comprises: a cylindrical melting chamber 3 having an internal diameter of about 2.0 m which contains the melt; an upper chamber 5; and a chimney for evacuation of the fumes. The upper chamber 5 is equipped with baffles 7 that prevent any melt projections thrown from the surface 18 of the melt being entrained into the fumes. A raw material feeder 10 is arranged at the upper chamber 5 and is designed to load fresh raw material including man-made mineral fibers into the melter 1 at a point 11 located above the melt surface 18 and close to the side wall of the melter. The feeder 10 comprises a horizontal feeding means, for example a feed screw, which transports the raw material mix to a hopper fastened to the melter, the bottom of which may be opened and closed by a vertical piston. In the alternative, an underlevel feeder may charge raw material directly into the melt, under the level of the melt. The bottom of the melting chamber comprises six submerged burners 21, 22, 23, 24, 25, 26 arranged on a circular burner line 27 concentric with the melter axis and having a diameter of about 1.4 m. The melt may be withdrawn from the melting chamber 3 through a controllable outlet opening 9 located in the melting chamber side wall, close to the melter bottom, substantially opposite the feeding device 10. The melt withdrawn from the melter may then be allowed to cool and ground as required. In the alternative, a syphon-type outlet may be used which concomitantly continuously controls the level of the melt in the melter.

The temperature within the melt may be between 1350° C. and 1450° C., preferably about 1400° C., depending on the composition of the melt, desired viscosity and other parameters. Preferably, the melter wall is a double steel wall cooled by a cooling liquid, preferably water. Cooling water connections provided at the external melter wall allow a flow sufficient to withdraw energy from the inside wall such that melt can solidify on the internal wall and the cooling liquid, here water, does not boil.

The melter 1 may be mounted on dampers adapted to absorb vibrational movements.

The submerged burners comprise concentric tube burners operated at gas flows of 100 to 200 m/s, preferably 110 to 160 m/s and generate combustion of fuel gas and oxygen containing gas within the melt. The combustion and combustion gases generate agitation within the melt before they escape into the upper chamber and then through the chimney. These hot gases may be used to preheat the raw material and/or the fuel gas and/or oxidant gas (eg oxygen, industrial oxygen have an oxygen content ≥95% by weight or oxygen enriched air) used in the burners. The fumes are preferably filtered prior to release to the environment, optionally using dilution with ambient air to reduce their temperature prior to filtering.

It has been found that the burner arrangement and control to obtain the above described toroidal melt flow pattern may ensure appropriate mixing in the melt as well as the required turbulence to sufficiently increase the melt volume (or reduce the melt density) to reach the objective of the present invention. Foam formation is particularly reduced, as the gas bubbles reaching the top of the melt are reabsorbed and mixed within the melt as a result of the toroidal flow pattern.

The molten basalt rock may then be discharged continuously or batch wise into an extrusion or filament bushing device 20 known per se for the formation of continuous basalt fibers. In an advantageous process, the molten basalt rock may be discharged directly into the forming device 20, that is without any intermediate refining step.

The obtained continuous fibers may be used as such or further treated or conditioned for downstream applications as appropriate.

The continuous fibers obtained are of high quality. The above described production process is less energy demanding then known processes, because of the choice of submerged combustion melters that allow for improved energy transfer to the melt, shorter residence times and thus less heat loss, and because the high turbulence and stirring leads to a more homogenous melt at reduced melt viscosity, which in turn may allow for operation at reduced temperatures. Furthermore, submerged combustion may advantageously be performed in water-cooled melters which are easier and less costly to maintain and repair and which further allow for recycling of the energy withdrawn from the cooling fluid.

1. A process for the manufacturing of continuous basalt fibers comprising the steps of:
a) introducing a solid batch material which comprises basalt rock for the preparation of continuous mineral fibers into a melter comprising a melter bottom, a melting chamber and melting chamber walls, wherein the melting chamber walls comprise double steel walls separated by circulating cooling liquid;
b) melting the solid batch material in the melter by submerged combustion to form a liquid melt; and
c) discharging the liquid melt directly into a forming device without any intermediate refining step, and forming at least a portion of the liquid melt into continuous basalt fibers.

2. The process of claim 1, wherein the solid batch material comprises 45.0-60.0 wt % SiO₂, 12.0-25.0 wt % Al₂O₃, 5.0-25.0 wt % iron oxide (Fe₂O₃), 2.0-6.0 wt % total alkali content, 5.0-25.0 wt % CaO, 4.0-25.0 wt % MgO, 0.0-5.0 wt % TiO₂ and trace amounts of other oxides to add up to 100 wt %.

3-4. (canceled)

5. The process of claim 1, wherein heat is recovered from hot fumes and/or from cooling liquid.

6. The process of claim 1, wherein heat is recovered from hot fumes to preheat the raw materials.

7. The process of claim 1, wherein at least a portion of the melt is withdrawn continuously or batchwise from the melter.

8. The process of claim 1, wherein the melter comprises at least one controllable submerged burner, to maintain the melt in a turbulent state such that the volume of the turbulent melt is at least 8% higher than the melt level if no burners are firing.

9. The process of claim 8, wherein the melter is operated such that substantially no foam layer is generated over the top of the melt.

10. The process of claim 1, wherein the submerged combustion generates a toroidal melt flow pattern in the melt, the toroidal melt flow pattern having a vertical central axis of revolution, and comprising major centrally inwardly convergent flows at the melt surface;
wherein the melt moves downwardly and proximal to the vertical central axis of revolution and is recirculated in an ascending movement back to the melt surface defining the toroidal flow pattern.

11. The process of claim 1, wherein the melting step comprises melting the solid batch material in a submerged combustion melter by subjecting the liquid melt to a flow pattern which when simulated by computational fluid dynamic analysis shows a toroidal melt flow pattern in the melt comprising major centrally inwardly convergent flow vectors at the melt surface, with a central axis of revolution of the toroid being vertical.

12. The process of claim 11, wherein the flow vectors exhibit outward and then upward orientation components, towards the melter bottom.

13. The process of claim 1, wherein the continuous basalt fibers are produced using equipment for the manufacturing of continuous basalt fibers comprising a submerged combustion melter (1), a melting chamber (3), walls (19), at least one submerged burner, a raw material discharge equipment or feeder (10), a melt outlet (9), and a continuous basalt fiber forming device (20), wherein the melt outlet is designed to discharge directly into the continuous basalt fiber forming device (20).

14. (canceled)

15. The process of claim 13, wherein submerged combustion burners (21,22,23,24,25,26) are arranged at the melter bottom in a substantially annular burner zone.

16. The process of claim 13, wherein the burners (21,22,23,24,25,26) are arranged with a distance between adjacent burners of about 250-1250 mm.

17. The process of claim 13, wherein each burner axis and/or a speed vector of the melt moving upwards over or adjacent to the submerged burners is inclined from the vertical at an angle from about 1° to about 30°.

18. The process of claim 13, wherein each central burner axis is inclined by a swirl angle of about 1° to about 30° with respect to a vertical plane passing through a central vertical axis of the melter and burner center.
